(19) United States
(12) Patent Application Publication
(10) Pub. No.: US 2004/0135562 A1
(43) Pub. Date: Jul. 15, 2004

(54) Single inductor multiple output switchmode power supply

(76) Inventor: Thomas Clark Oden, Oklahoma City, OK (US)

Correspondence Address: Kirk A. Cesari, Seagate Technology LLC, 1280 Disc Drive, Shakopee, MN, 55379, US

(21) Appl. No.: 10/341,184

(22) Filed: Jan. 13, 2003

(51) Int. Cl. G05F 1/40

(52) U.S. Cl. 323/282

(57) ABSTRACT

A switchmode power supply for producing a plurality of output voltages using a single inductor. The inductor is provided with opposing first and second terminals. A first switch is connected between the first terminal and a source of electrical power to charge the inductor. A negative output of the power supply comprises a first capacitor and a second switch which switches electrical current from the first terminal to the negative output. A positive output of the power supply comprises a second capacitor and a third switch which switches electrical current from the second terminal to the positive output. Energy is stored in the inductor during an inductor charging cycle by closing the first switch. The stored energy is transferred to at least one of the negative and positive outputs during an inductor discharge cycle.

### FIELD OF THE INVENTION

This invention relates generally to the field of electrical power supplies and more particularly, but not by way of limitation, to a switchmode power supply which outputs multiple regulated output voltages using a single inductor.

### BACKGROUND

It is common for modern electronic circuits to require multiple source voltage levels to operate (e.g., 3.3 volts (V), 5V, −5V, etc.). Using present voltage regulating schemes, a significant number of components are typically required for each output voltage produced. As the number of required voltages increases, the cost of the power supply and the space requirements likewise tend to increase.

In a typical switchmode regulator, electrical current is directed to an inductor to store energy in the inductor. The stored energy is then delivered to a capacitor by appropriate switching of the inductor current. Regulators with multiple outputs typically employ a separate inductor for each output. Depending on the switching of the inductor current, a switchmode regulator may be wired in any one of a variety of well known configurations, such as a boost configuration, a buck configuration, a boost/buck configuration, a negative configuration or a flyback configuration. Such schemes allow a regulator deliver an output voltage which is lower than the input voltage, higher than the input voltage, or negative with respect to the input voltage.

Data storage devices such as disc drives typically utilize communication and control electronics that employ a number of different operational voltages, such as 1.2V, 2.5V, 3.3V, 5V, 20V and −5V. Historically, the various voltages required for such electronics have often been generated, or controlled, by an analog application specific integrated circuit (“ASIC”) motor control chip. Each supply voltage has typically accounted for at least four pins on the ASIC and required a number of external components, e.g., resistors, capacitors, a MOSFET switch, one or more diodes, an inductor, and a filter capacitor.

In addition to the cost of these parts, such schemes have also increased the cost of the ASIC due to the large number of pins which must be dedicated to producing multiple output voltages. Moreover, with ever changing voltage requirements, it is generally difficult to design a platform motor controller ASIC for use across several models of disc drives. This is especially true in light of the fact that current loading for each output voltage may vary significantly from drive-to-drive during operation.

Accordingly, there is a continuing need for improvements in the art whereby multiple output voltages can be produced with fewer external components, and requiring fewer pins on the regulator chip, while improving the range of current loading available on each output.

### SUMMARY OF THE INVENTION

As embodied herein and as claimed below, the present invention is generally directed to a switchmode power supply which outputs multiple regulated output voltages. In a preferred embodiment, the switchmode power supply is incorporated for use in a data storage device such as a disc drive.

The switchmode power supply preferably comprises a single inductor having opposing first and second terminals. A first switch is connected between the first terminal and a source of electrical power for charging the inductor.

A negative output of the power supply comprises a first capacitor and a second switch which switches electrical current from the first terminal to the negative output. A positive output of the power supply comprises a second capacitor and a third switch which electrical current from the second terminal to the positive output.

Energy is stored in the inductor during an inductor charging cycle by closing the first switch. The stored energy is transferred to at least one of the negative and positive outputs during an inductor discharge cycle.

Preferably, a fourth switch is further connected between the first terminal and a return path for the source of electrical power, and a fifth switch is further connected between the second terminal and the return path. In this way, electrical current is delivered to the positive output during the inductor discharge cycle when the second switch is open and the fourth switch is closed, and electrical current is delivered to the negative output during the inductor discharge cycle when the third switch is open and the fifth switch is closed.

The power supply preferably further includes a recirculation path for the inductor to conserve energy stored in the inductor when electrical current is not directed to both the negative output and the positive output. The recirculation path is preferably formed by closing the respective fourth and fifth switches.

The power supply can further be provided with a boost output which outputs a boost voltage greater than a voltage of the source of electrical power. The boost output comprises a third capacitor and a sixth switch connected between the second terminal and the output. The sixth switch is open during the inductor charge cycle and closed during the inductor discharge cycle to deliver electrical current from the inductor to the boost output.

These and various other features and advantages which characterize the claimed invention will be apparent from a reading of the following detailed description and a review of the associated drawings.

### BRIEF DESCRIPTION OF THE DRAWINGS

FIG. 1 is a top plan view of a disc drive type data storage device constructed and operated in accordance with preferred embodiments of the present invention.

FIG. 2 shows a circuit block diagram for a multi-output switchmode regulator that can be used, for example, in the disc drive data storage device of FIG. 1.

FIG. 3 illustrates current paths for charging a positive output during the inductor charge and discharge cycles.

FIG. 4 illustrates a current path for charging a negative output during the inductor discharge cycle.

FIG. 5 illustrates a current path for charging a boost output during the inductor discharge cycle.

FIG. 6 illustrates a current path for recirculating the inductor current to conserve the charge stored in the inductor.

FIG. 7 shows a circuit block diagram for alternative methods of recirculating inductor current.

### DETAILED DESCRIPTION

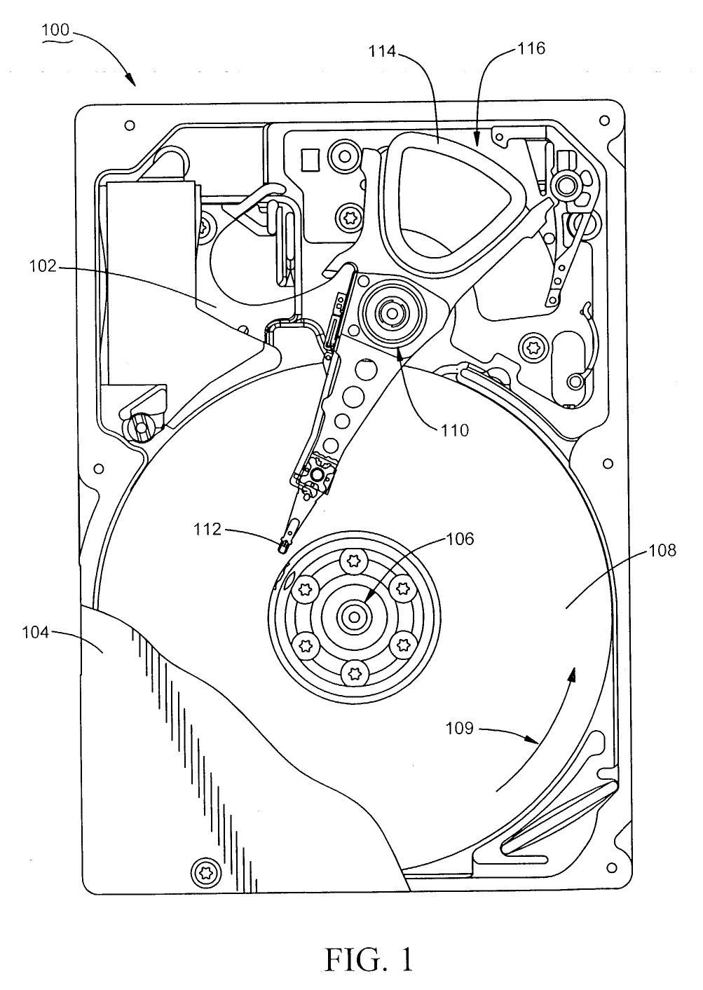

To provide an exemplary environment in which preferred embodiments of the present invention can be advantageously practiced, FIG. 1 shows a disc drive type data storage device 100 configured to store and retrieve digital data. A base deck 102 cooperates with a top cover 104 (shown in partial cutaway) to form an environmentally controlled housing for the device 100.

A spindle motor 106 supported within the housing rotates a number of rigid magnetic recording discs 108 in a rotational direction 109. An actuator 110 is provided adjacent the discs 108 and moves a corresponding number of heads 112 across the disc recording surfaces through application of current to an actuator coil 114 of a voice coil motor (VCM) 116. Communication and control electronics for the disc drive 100 are provided on a disc drive printed circuit board (PCB) mounted to the underside of the base deck 102.

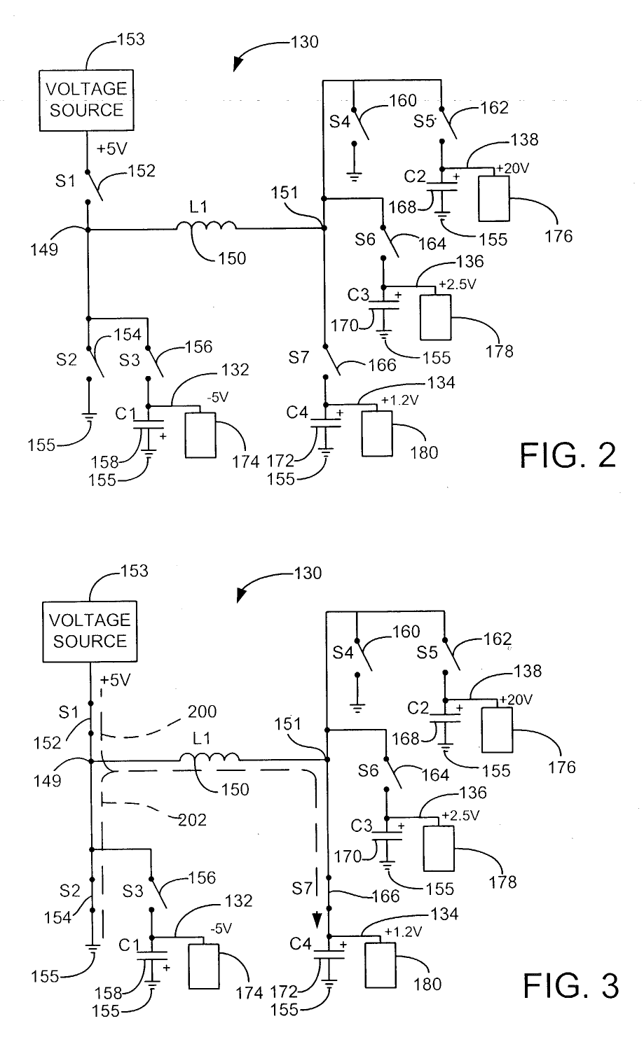

As will be appreciated by those skilled in the art, various operational voltages are needed to operate the analog and digital circuitry of the device 100 as well as to operate the spindle motor 106 and VCM 116. Referring to FIG. 2, these operational voltages are preferably supplied by a switchmode regulator 130 (also referred to as a regulator and as a switchmode power supply).

In this illustrative example, it is contemplated that the regulator 130 is embodied in circuitry mounted to a printed circuit board (PCB) mounted to the underside of the base deck 102 (FIG. 1). It will be readily understood, however, that the regulator 130 can be utilized in any number of device applications.

The regulator 130 provides a plurality of outputs 132, 134, 136, and 138 that provide different output voltage levels. For purposes of the present discussion, it will be contemplated that the outputs 132, 134, 136 and 138 have respective regulated voltage levels of −5 volts (V), +1.2V, +2.5V and +20V. It will be understood, however, that any number and magnitudes of different voltage levels can be provided as desired, so that the disclosed output levels are for purposes of illustration and are not limiting.

The regulator 130 includes a single inductor 150 (L1), an inductor charging switch 152 (S1), an inductor discharging switch 154 (S2), a negative output switch 156 (S3), a negative output filter capacitor 158 (C1), a recirculation switch 160 (S4), first, second, and third positive output switches 162, 164 and 166 (S5, S6 and S7), respectively, and first, second and third positive output filter capacitors 168, 170, and 172 (C2, C3 and C4), respectively. Each of the outputs 132, 134, 136 and 138 drives an associated load 174, 176, 178 and 180.

The regulator 130 uses a single inductor (150) to charge any number of regulated outputs (4 shown). Outputs may be configured as positive (or buck) outputs, i.e. outputs 134 and 136, negative outputs, i.e. output 132, or a boost output, i.e. output 138. As will become apparent from the discussion below, one difference between a positive output and a boost output is in the switching of the inductor current associated with the particular output.

Generally, the circuitry of the regulator 130 shown in FIG. 2 operates to repetitively charge and discharge the inductor 150 to output multiple regulated output voltages, including a positive output voltage with respect to ground (e.g., output 134) and a negative output voltage with respect to ground (e.g., output 132).

During a charge cycle, S1 switch 152 is closed to connect a first terminal 149 of the inductor 150 to a voltage source 153 (which outputs a positive supply voltage V+, contemplated in the present example as +5V). An opposing, second terminal 151 of the inductor 150 is connected to electrical ground 155, either by charging a positive output by closing either S7 switch 166 or S6 switch 164, or alternatively by closing S4 switch 160.

During a discharge cycle, a selected one of a first group of switches comprising S2 and S3 switches 154, 156 is closed. Additionally, during a discharge cycle at least a selected one of a second group of switches comprising S4, S5, S6 and S7 switches 160, 162, 164, 166 is closed. Generally, in the first group of switches, S3 switch 156 is closed if the negative output 132 is in need of additional charge, otherwise S2 switch 154 is closed. In the second group of switches, any of the S5, S6 and S7 switches 162, 164, 166 are closed if the respective outputs 138, 136, 134 are in need of additional charge, otherwise S4 switch 160 is closed.

Preferred operation of the regulator 130 under various conditions will now be discussed in greater detail with reference to FIGS. 3-7. Turning to FIG. 3, if output 134 is in need of charge, as indicated by the voltage at output 134 falling below a threshold, C2 capacitor 172 can be charged through either an inductor charge cycle as indicated along path 200, an inductor discharge cycle as indicated by path 202, or both. Path 200 allows electrical current to flow from the voltage source 153 to C2 capacitor 172 by closing S1 and S7 switches 152 and 166. Preferably prior to saturating the L1 inductor 150, the regulator 130 transitions from the inductor charge cycle, by opening S1 switch 152, to an inductor discharge cycle, as indicated by path 202, by closing S2 switch 154.

As will be familiar to those skilled in the art, an inductor resists sudden changes in electrical current and thus, current will generally continue to flow through the L1 inductor 150 in the same direction as during the charge cycle until the energy stored in the inductor has been depleted. At that point, the regulator 130 will repeat the cycle by opening S2 switch 154 and closing S1 switch 152 until the voltage at output 134 reaches a predetermined threshold. When no more charge is needed at the output 134, S7 switch 166 is opened. The operation of output 136 is generally identical to that of output 134 except S6 switch 164 is closed rather than S7 switch 166.

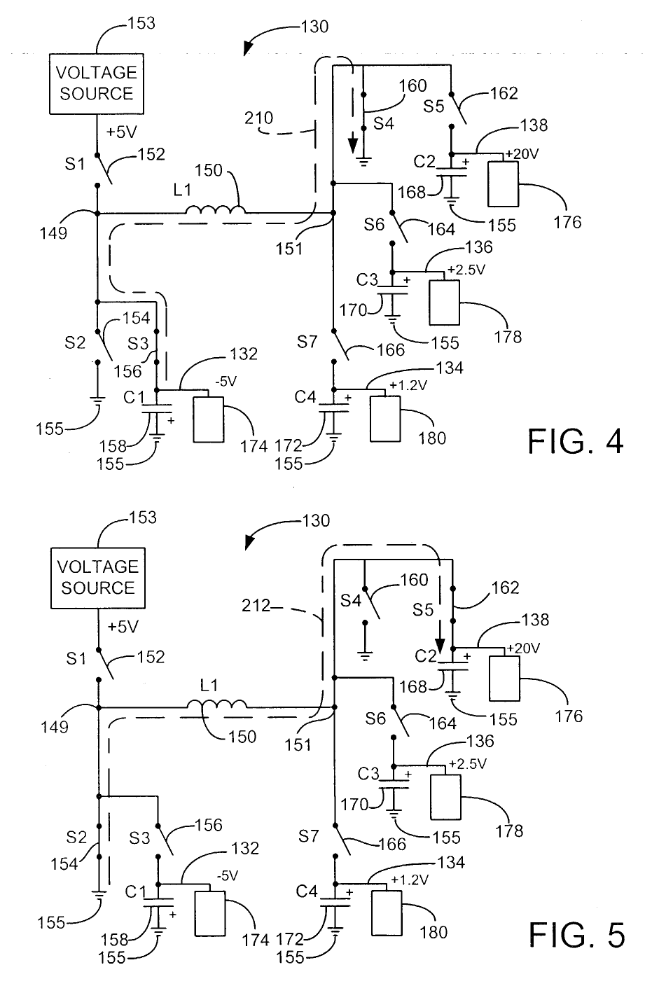

FIG. 4 shows a current path 210 for producing a negative voltage at output 132. When the voltage at output 132 rises above a predetermined threshold, the regulator 130 first performs an inductor charge cycle as described above. During both the inductor charge and discharge cycles, if charge is needed at output 134 or output 136, either S7 switch 166 or S6 switch 164, respectively, will be closed. If no charge is needed at outputs 134 and 136, S4 switch 160 will be closed during either or both the charge and discharge cycles.

As mentioned in the previous example, before the L1 inductor 150 saturates, the regulator 130 preferably transitions from an inductor charge cycle by opening S1 switch 152 to an inductor discharge cycle, according to path 210, by closing S3 switch 156. Again, the inductor current will tend to continue to flow in the same direction as during the charge cycle and thus charge the C3 capacitor 168 to a negative voltage. Because the current continues to flow in the same direction, charge can be added to the positive outputs 134 and 136 during the discharge cycle while also charging the negative output 132.

FIG. 5 shows a discharge current path 212 for producing a voltage higher than the supply voltage (boost configuration) at output 138. Once again, a charge cycle is first performed by closing S1 switch 152 and either S4, S6 or S7 switch 160, 164, 166, depending on the need for charge at outputs 134 or 136 Prior to saturating the L1 inductor 150, the regulator 130 transitions from an inductor charge cycle, by opening closed S4, S6 or S7 switch 160, 164 or 166, and closing S2 and S5 switches 154, 162.

As before, the current flowing through the L1 inductor 150 will tend to continue to flow in the same direction until the energy stored in the L1 inductor 150 is depleted, resulting in the charging of the C3 capacitor 168. It should be noted that, if output 132 is in need of additional charge, the regulator 130 will open S1 and S2 switches 152, 154 and close S3 switch 156 at the start of the discharge cycle to add negative charge to the C1 capacitor 158 while adding positive charge to the C3 capacitor 168.

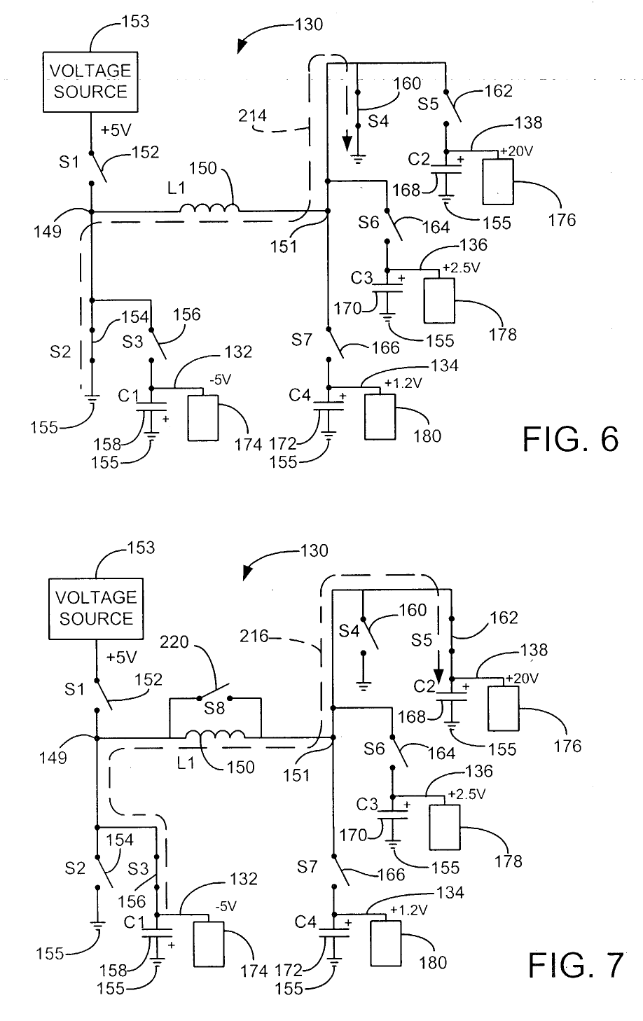

Referring next to FIG. 6, an additional feature of the regulator 130 is the ability to recirculate inductor current when no output is demanding additional charge. For example, when an inductor charge cycle completes but no output is in need of additional charge, the L1 inductor 150 will be left with retained stored energy. If simply disconnected, the voltage across the L1 inductor 150 would rise to unacceptable levels, the voltage across the inductor being defined as:

V=L*dI/dt (1)

where:

V is the inductor voltage;

L is the inductance of the inductor; and

dI/dt is the change in inductor current with respect to time.

It is thus generally desirable to provide a path to handle such stored energy. One option would simply be to provide a switch to a resistive load to dissipate the energy as heat. While effective, this solution adds components and wastes energy. Another approach is to provide a low impedance recirculation path for the current stored in the inductor. In light of the above equation, it can be seen that if the inductor voltage is taken to zero, the change in current with respect to time will also be zero.

While realistically it has been found difficult to achieve zero volts, it can be seen that the lower the impedance across the L1 inductor 150, the lower the resulting voltage will be and the longer it will take to deplete the energy stored in the inductor. Thus, if an inductor charge cycle completes but no outputs are in need of additional charge, the regulator 130 will open S1 switch 152 and close S2 and S4 switches 154 and 160 to complete a recirculation path 216 through circuit ground 155, as shown by FIG. 7. Assuming there is a need for charge before the energy is dissipated from the L1 inductor 150, the energy will still be available to charge the output, thereby improving the efficiency of the regulator 130.

Alternatively, as shown in FIG. 7, an S8 switch 220 can be placed directly across the L1 inductor 150 to form a recirculation path. When recirculation is needed, S8 switch 220 is closed. Upon the need for additional charge at an output, S8 switch 220 is opened, the charge stored in L1 inductor 150 is delivered to the output, and normal operation resumes.

While preferred embodiments of the present invention have been described as having a single negative output, a single boost output, and two buck outputs, the invention is not so limited. As dictated by the needs of the system in which the inventive power supply (regulator) is employed, any number of positive and negative outputs can be provided, in any arrangement of configurations.

The regulator 130 is well suited for integration into a single integrated circuit. Control circuitry to operate the regulator 130 as described above can be readily embodied in analog and digital circuitry, as a series of programming steps within a programmable device such as a microprocessor, an FPGA, a programmable logic array, and the like.

Finally, it will also be apparent to those skilled in the art that while preferred embodiments of the regulator 130 have been described for use in the data 30 storage device 100, the claimed invention is not necessarily so limited. Rather, the regulator 130 is well suited to a wide range of applications including portable battery operated devices.

It will now be understood that the present invention (as embodied herein and as claimed below) is generally directed to a switchmode power supply (such as 130) which outputs multiple regulated output voltages. In a preferred embodiment, the switchmode power supply is incorporated for use in a data storage device (such as 100).

The switchmode power supply comprises a single inductor (such as 150) having opposing first and second terminals. A first switch (such as 152) is connected between the first terminal and a source of electrical power (such as 153) for charging the inductor.

A negative output of the power supply (such as 132) comprises a first capacitor (such as 158) and a second switch (such as 156) which switches electrical current from the first terminal to the negative output. A positive output of the power supply (such as 134) comprises a second capacitor (such as 172) and a third switch (such as 166) which switches electrical current from the second terminal to the positive output.

Energy is stored in the inductor during an inductor charging cycle by closing the first switch. The stored energy is transferred to at least one of the negative and positive outputs during an inductor discharge cycle.

Preferably, a fourth switch (such as 154) is further connected between the inductor first terminal and a return path for the source of electrical power, and a fifth switch (such as 160) is further connected between the second terminal and the return path. In this way, electrical current is delivered to the positive output during the inductor discharge cycle when the second switch is open and the fourth switch is closed, and electrical current is delivered to the negative output during the inductor discharge cycle when the third switch is open and the fifth switch is closed.

The power supply preferably further includes a recirculation path for the inductor to conserve energy stored in the inductor when electrical current is not directed to both the negative output and the positive output. The recirculation path is preferably formed by closing the respective fourth and fifth switches.

The power supply can further be provided with a boost output (such as 138) which outputs a boost voltage greater than the voltage of the source of electrical power. The boost output comprises a third capacitor (such as 164) and a sixth switch (such as 162) connected between the second terminal and the output. The sixth switch is open during the inductor charge cycle and closed during the inductor discharge cycle to deliver electrical current from the inductor to the boost output.

For purposes of the appended claims, the term single inductor will be understood to cover both a unitary inductor as well as multiple inductors that are directly connected in series or parallel without intervening components therebetween. The recited first means will be understood to correspond to the circuitry of FIGS. 2-7 except for the L1 inductor 150.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application of the switchmode power supply without departing from the spirit and scope of the present invention.

In addition, although the embodiments described herein are generally directed to a switchmode power supply used in a disc drive data storage device, it will be appreciated by those skilled in the art that the power supply can be used in various other types of electrical systems without departing from the spirit and scope of the claimed invention.

What is claimed is:

1. A switchmode power supply which outputs multiple regulated output voltages, comprising:
a single inductor having opposing first and second terminals;
a first switch connected between the first terminal and a source of electrical power for charging the inductor;
a negative output comprising a first capacitor and a second switch for switching electrical current from the first terminal to the negative output; and
a positive output comprising a second capacitor and a third switch for switching electrical current from the second terminal to the positive output, wherein energy is stored in the inductor during an inductor charging cycle by closing the first switch and the stored energy is transferred to at least one of the negative and positive outputs during an inductor discharge cycle.

2. The switchmode power supply of claim 1, further comprising:
a fourth switch connected between the first terminal and a return path for the source of electrical power; and
a fifth switch connected between the second terminal and the return path, wherein electrical current is delivered to the positive output during the inductor discharge cycle when the second switch is open and the fourth switch is closed, and wherein electrical current is delivered to the negative output during the inductor discharge cycle when the third switch is open and the fifth switch is closed.

3. The switchmode power supply of claim 2, further comprising a recirculation path for the inductor to conserve energy stored in the inductor when electrical current is not directed to both the negative output and the positive output.

4. The switchmode power supply of claim 3, wherein the recirculation path is formed by closing the respective fourth and fifth switches.

5. The switchmode power supply of claim 1, further comprising a boost output comprising a third capacitor and a sixth switch connected between the second terminal and the output, wherein the sixth switch is open during the inductor charge cycle and closed during the inductor discharge cycle to deliver electrical current from the inductor to the boost output.

6. The switchmode power supply of claim 1, wherein the stored energy is further transferred to at least one of the negative and positive outputs during an inductor charge cycle.

7. A data storage device which utilizes the multiple operating voltages provided by the switchmode power supply of claim 1.

8. A switchmode power supply, comprising:
a single inductor having opposing first and second terminals; and
first means for charging and discharging the single inductor to output multiple regulated output voltages including a positive output voltage with respect to ground and a negative output voltage with respect to ground.

9. The switchmode power supply of claim 8, wherein the first means comprises:
a first switch connected between the first terminal and a source of electrical power for charging the inductor;
a negative output which provides the negative output voltage and comprises a first capacitor and a second switch for switching electrical current from the first terminal to the negative output; and
a positive output which provides the positive output voltage and comprises a second capacitor and a third switch for switching electrical current from the second terminal to the positive output, wherein energy is stored in the inductor during an inductor charging cycle by closing the first switch and the stored energy is transferred to at least one of the negative and positive outputs during an inductor discharge cycle.

10. The switchmode power supply of claim 9, wherein the first means further comprises:
a fourth switch connected between the first terminal and a return path for the source of electrical power; and
a fifth switch connected between the second terminal and the return path, wherein electrical current is delivered to the positive output during the inductor discharge cycle when the second switch is open and the fourth switch is closed, and wherein electrical current is delivered to the negative output during the inductor discharge cycle when the third switch is open and the fifth switch is closed.

11. The switchmode power supply of claim 10, wherein the first means further comprises a recirculation path for the inductor to conserve energy stored in the inductor when electrical current is not directed to both the negative output and the positive output.

12. The switchmode power supply of claim 11, wherein the recirculation path is formed by closing the respective fourth and fifth switches.

13. The switchmode power supply of claim 9, wherein the first means further comprises a boost output which provides a boost output voltage greater than a voltage of the source for electrical power, the boost output comprising a third capacitor and a sixth switch connected between the second terminal and the output, wherein the sixth switch is open during the inductor charge cycle and closed during the inductor discharge cycle to deliver electrical current from the inductor to the boost output.

14. A data storage device which utilizes multiple operating voltages provided from a switchmode power supply incorporated in the data storage device and comprising:
an inductor having opposing first and second terminals;
a first switch connected between the first terminal and a source of electrical power for charging the inductor;
a negative output comprising a first capacitor and a second switch for switching electrical current from the first terminal to the negative output; and
a positive output comprising a second capacitor and a third switch for switching electrical current from the second terminal to the positive output, wherein energy is stored in the inductor during an inductor charging cycle by closing the first switch and the stored energy is transferred to at least one of the negative and positive outputs during an inductor discharge cycle.

15. The data storage device of claim 14, wherein the switchmode power supply further comprises:
a fourth switch connected between the first terminal and a return path for the source of electrical power; and
a fifth switch connected between the second terminal and the return path, wherein electrical current is delivered to the positive output during the inductor discharge cycle when the second switch is open and the fourth switch is closed, and wherein electrical current is delivered to the negative output during the inductor discharge cycle when the third switch is open and the fifth switch is closed.

16. The data storage device of claim 15, wherein the switchmode power supply further comprises a recirculation path for the inductor to conserve energy stored in the inductor when electrical current is not directed to both the negative output and the positive output.

17. The data storage device of claim 16, wherein the recirculation path of the switchmode power supply is formed by closing the respective fourth and fifth switches.

18. The data storage device of claim 14, wherein the switchmode power supply further comprises a boost output comprising a third capacitor and a sixth switch connected between the second terminal and the output, wherein the sixth switch is open during the inductor charge cycle and closed during the inductor discharge cycle to deliver electrical current from the inductor to the boost output.

19. The data storage device of claim 14, wherein the stored energy is further transferred to at least one of the negative and positive outputs during an inductor charge cycle.
